(19) United States
(12) Patent Application Publication
(10) Pub. No.: US 2009/0147128 A1
(43) Pub. Date: Jun. 11, 2009

(54) Digital photographing apparatus

(75) Inventor: Inh-seok Suh, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/315,230

(22) Filed: Dec. 1, 2008

(30) Foreign Application Priority Data
Dec. 10, 2007 (KR) 10-2007-0127577

(51) Int. Cl. H04N 5/225

(52) U.S. Cl. 348/374; 348/E05.025

(57) ABSTRACT

A digital photographing apparatus is provided that has a reduced number of elements as compared to conventional arrangements and can thus be manufactured through a simple process with low manufacturing costs. The digital photographing apparatus includes a main printed circuit board to which an imaging device converting energy of incident light into electrical signals is directly attached. The digital photographing apparatus also includes an optical tube unit connected to the main printed circuit board and forming an image in the imaging device by receiving an external image. A first contact formed at a surface of the optical tube unit is directly in contact with a second contact formed at a surface of the main printed circuit board.

### CROSS-REFERENCE TO RELATED PATENT APPLICATION

This application claims the benefit of Korean Patent Application No. 10-2007-0127577, filed on Dec. 10, 2007 in the Korean Intellectual Property Office, the entire contents of which is incorporated herein by reference.

### BACKGROUND OF THE INVENTION

1. Field of the Invention

The present invention relates to a digital photographing apparatus. More particularly, the present invention relates to a digital photographing apparatus that has a reduced number of elements and can thus be manufactured at a low cost.

2. Description of the Related Art

Generally speaking, a digital photographing apparatus stores image data obtained in a photographing operation into storage media in a photographing mode. The digital photographing apparatus displays an image on a display unit of the apparatus using the stored image data obtained from the storage media.

In such a digital photographing apparatus, light passing through an optical tube unit including lenses is incident onto an imaging device. As a result, image data is obtained in the imaging device. Thus, the digital photographing apparatus essentially includes an imaging device and an optical tube unit.

FIG. 1 is an exploded perspective view schematically illustrating an example of an imaging device assembly and an optical tube unit of a conventional digital photographing apparatus. FIG. 2 is a cross-sectional view taken along line II-II in FIG. 1.

Referring to FIGS. 1 and 2, an imaging device assembly includes a flexible printed circuit board 1 for an imaging device, an imaging device 2 attached to the flexible printed circuit board for an imaging device 1, and an imaging device plate interposed between the flexible printed circuit board for an imaging device 1 and the imaging device 2. The flexible printed circuit board for an imaging device 1 includes a terminal 1a connected via a connector to a main printed circuit board 7. The main printed circuit board 7 includes a CPU, which controls the entire operation of the digital photographing apparatus, and a digital signal processor. The imaging device 2 includes a terminal 2a which passes through the flexible printed circuit board for an imaging device 1 and is fixed at a rear surface of the flexible printed circuit board for an imaging device 1 by soldering.

Meanwhile, a flexible printed circuit board 6 for an optical tube unit includes a terminal 6a connected via connector and is connected to the main printed circuit board 7.

The flexible printed circuit board for an optical tube unit 6 is assembled to a rear surface of an optical tube unit 5. An imaging device assembly is assembled to a rear surface of the flexible printed circuit board for an optical tube unit 6 by aligning the imaging device assembly and the optical tube unit 5 such that light passing through the optical tube unit 5 is incident onto the imaging device 2. The main printed circuit 7 is connected to a rear surface of the imaging device assembly. Then, the flexible printed circuit board for an imaging device 1 and the flexible printed circuit board for an optical tube unit 6 are respectively connected to the main printed circuit board 7 through connectors using terminals 1a and 6a.

However, the above-described conventional digital photographing apparatus, which includes an imaging device assembly and an optical tube unit as shown in FIGS. 1 and 2, has a large number of elements. As a result, the conventional digital photographing apparatus has a complicated structure, it's associated manufacturing process is complex, the manufacturing yield is low, the defect rate is high, and manufacturing costs are high.

### SUMMARY OF THE INVENTION

The present invention provides a digital photographing apparatus that has a reduced number of elements and can be manufactured through a simple process with low manufacturing costs.

According to an embodiment of the present invention, a digital photographing apparatus is provided that includes: a main printed circuit board to which an imaging device converting energy of incident light into electrical signals is directly attached; and an optical tube unit connected to the main printed circuit board and forming an image in the imaging device by receiving an external image, wherein a first contact formed at a surface of the optical tube unit is directly in contact with a second contact formed at a surface of the main printed circuit board.

The first contact and the second contact may be electrically interconnected to electrically connect the optical tube unit and the main printed circuit board.

The imaging device may be attached to the main printed circuit board such that the rear surface of the imaging device contacts the surface of the main printed circuit board.

The optical tube unit may be directly assembled to the main printed circuit board such that light passing through the optical tube unit is incident onto the imaging device attached to the main printed circuit board.

The digital photographing apparatus may further include a first assembling element for assembling the optical tube unit and the main printed circuit board.

The second contact may be formed at a portion of the main printed circuit board corresponding to the first contact of the optical tube unit such that the first contact is in contact with the second contact when the optical tube unit is assembled to the main printed circuit board.

The optical tube unit may include a flexible printed circuit board for an optical tube unit, and the first contact is formed on a surface of the flexible printed circuit board for an optical tube unit.

The digital photographing apparatus may further include: a frame; and a top printed circuit board (PCB) including a button element disposed on the upper portion of the digital photographing apparatus, wherein the top PCB is disposed on the upper portion of the frame and the main printed circuit board is disposed at a side of the frame.

According to the digital photographing apparatus of the present invention, the number of elements can be reduced. As a result, the digital photographing apparatus can be manufactured through a simple process with low manufacturing costs.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view schematically illustrating an example of an imaging device and an optical tube unit of a conventional digital photographing apparatus;

FIG. 2 is a cross-sectional view taken along line II-II in FIG. 1;

FIG. 3 is an exploded perspective view schematically illustrating an example of a main printed circuit board and an optical tube unit of a digital photographing apparatus according to an embodiment of the present invention;

FIG. 4 is a cross-sectional view taken along line IV-IV in FIG. 3;

FIG. 5 is a rear exploded perspective view schematically illustrating the main printed circuit board and the optical tube unit of FIG. 3, according to an embodiment of the present invention;

FIG. 6 is a perspective view of an example of a main printed circuit board-optical tube unit assembly in which the main printed circuit board and the optical tube unit of FIG. 3 are assembled, according to an embodiment of the present invention;

FIG. 7 is an exploded perspective view of an example of a digital photographing apparatus schematically illustrating a frame, a top printed circuit board assembly assembled to the frame, and a main printed circuit board-optical tube unit assembly, according to an embodiment of the present invention; and

FIG. 8 is a perspective view of an example of a digital photographing apparatus in which a main printed circuit board-optical tube assembly is assembled to a top printed circuit board, according to an embodiment of the present invention.

### DETAILED DESCRIPTION OF THE INVENTION

Hereinafter, the present invention will now be described more fully with reference to the accompanying drawings, in which exemplary embodiments of the invention are shown.

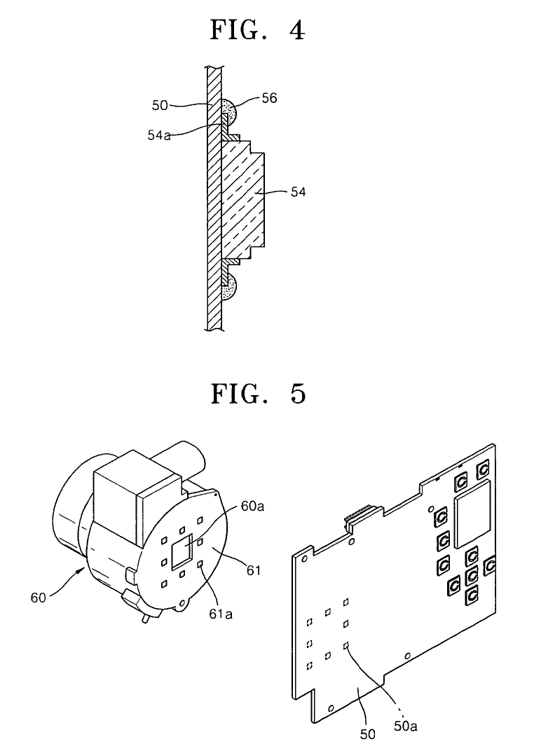

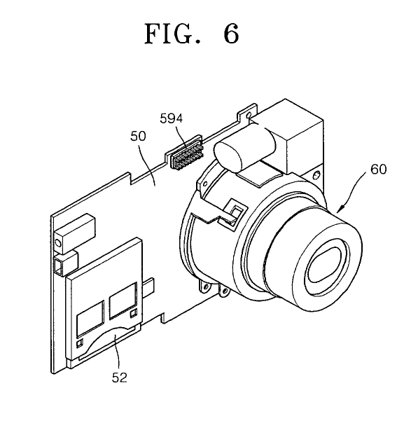

FIG. 3 is an exploded perspective view schematically illustrating an example of a main printed circuit board and an optical tube unit of a digital photographing apparatus according to an embodiment of the present invention. FIG. 4 is a cross-sectional view taken along line IV-IV in FIG. 3. FIG. 5 is a rear exploded perspective view schematically illustrating the main printed circuit board and the optical tube unit of FIG. 3, according to an embodiment of the present invention. FIG. 6 is a perspective view of an example of a main printed circuit board-optical tube unit assembly in which the main printed circuit board and the optical tube unit of FIG. 3 are assembled, according to an embodiment of the present invention.

Referring to the drawings above, a digital photographing apparatus according to the present invention includes a main printed circuit board 50 to which a control element 52 that controls the digital photographing apparatus and an imaging device 54 are directly attached.

In a conventional digital photographing apparatus, an imaging device assembly including a flexible printed circuit board for an imaging device, an imaging device attached to the flexible printed circuit board for an imaging device and an imaging device plate interposed between the imaging device and the flexible printed circuit board is prepared. Then, the prepared imaging device assembly is connected to a main printed circuit board through a connector.

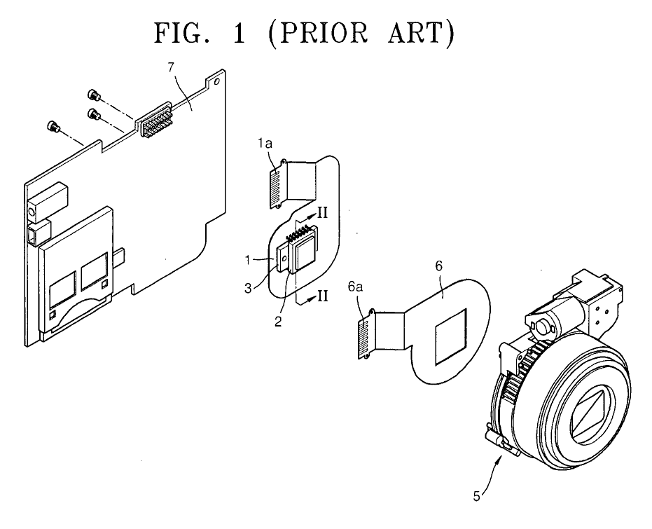

However, in the digital photographing apparatus according to the present invention, the imaging device 54 is directly attached to a main printed circuit board 50. Accordingly, a printed circuit board 1 for an imaging device, an imaging device plate 3 and a connector (not shown) connecting the printed circuit board for an imaging device 1 and the main printed circuit board are not necessary unlike in the conventional digital photographing apparatus shown in FIG. 1. As a result, in the digital photographing apparatus of the present invention, the number of elements of the digital photographing apparatus can be reduced. As a result, the digital photographing apparatus can be manufactured through a simple process with low manufacturing costs and a low defect rate.

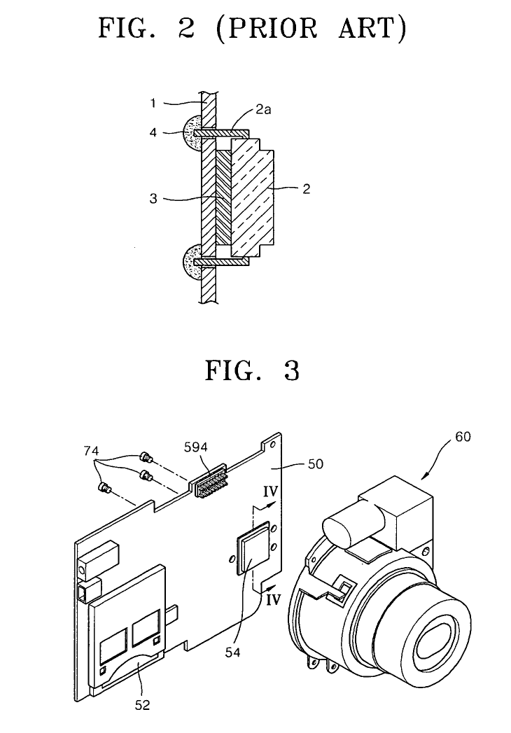

Meanwhile, in the conventional digital photographing apparatus shown in FIG. 2, the imaging device 2 includes the terminal 2a which passes through the flexible printed circuit board for an imaging device 1 and is fixed at a rear surface of the flexible printed circuit board for an imaging device 1 by soldering. Also, the imaging device plate 3 is interposed between the flexible printed circuit board 1 and the imaging device 2. The imaging device plate 3 is interposed therebetween since the imaging device 2 may be damaged while the imaging device assembly is connected to the main printed circuit board using a connector, or the like, and completely fixed due to the flexible properties of the flexible printed circuit board.

In addition, the flexible printed circuit board 1 cannot be easily handled during soldering or the imaging device 2 cannot be appropriately fixed on the flexible printed circuit board 1 when the imaging device 2 is fixed on the flexible printed circuit board 1 by soldering. Furthermore, the imaging device assembly can be fixed to the main printed circuit board by assembling the imaging device plate 3 and the main printed circuit board using an assembling element through an opening formed in the imaging device plate 3.

However, in the digital photographing apparatus according to the present invention, the imaging device 54 is directly attached to the main printed circuit board 50, which is not flexible, as shown in FIGS. 3 to 5, and thus an additional imaging device plate is not necessary. In addition, the imaging device 54 is attached to the main printed circuit board 50 such that the rear surface of the imaging device 54 contacts the main printed circuit board 50 as shown in FIG. 4, and thus, an empty space is not formed therebetween. Since the printed circuit board 50 to which the imaging device 54 is attached is not flexible, the process of fixing the terminal 54a of the imaging device 54 to the main printed circuit board 50 by soldering can be easily handled.

Meanwhile, the digital photographing apparatus according to the present invention may further include an optical tube unit 60 having a lens, a diaphragm, and the like. This optical tube unit 60 is directly assembled to the main printed circuit board 50. Light passing through the optical tube unit 60 may be incident onto the imaging device 54 attached to the main printed circuit board 50. In this regard, the optical tube unit 60 and the main printed circuit board 50 may be assembled using a first assembling element 74 such as, for example, a screw. For example, the optical tube unit 60 may be assembled to the main printed circuit board 50 by the first assembling element 74 at peripheral regions of the imaging device 54 through the rear surface of the main printed circuit board 50.

Here, the optical tube unit 60 and the imaging device 54 need to be accurately aligned since light passing through the optical tube unit 60 needs to be precisely incident onto the imaging device 54. In the digital photographing apparatus according to the present invention, the alignment between the optical tube unit 60 and the imaging device 54 can be precisely controlled when the optical tube unit 60 is assembled to the main printed circuit board 50 because the imaging device 54 is directly attached to the main printed circuit board 50.

Meanwhile, in the conventional digital photographing apparatus shown in FIG. 2, the flexible printed circuit board for an imaging device 1 and the flexible printed circuit board for an optical tube unit 6 respectively include the terminals 1a and 6a and connected to the main printed circuit board 7 including a CPU which controls the entire operation of the digital photographing apparatus and a digital signal processor via respective connectors

However, in the digital photographing apparatus according to the present invention as shown in FIGS. 3 and 4, a first contact 61a is formed at a surface of the optical tube unit 60 and a second contact 50a is formed at a surface of the main printed circuit board 50 and the first contact 61a and the second contact 50a are directly electrically connected.

Specifically, a flexible printed circuit board for an optical tube unit 61 is assembled to the rear surface of an optical tube unit 60 assembled to the main printed circuit board 50. In addition, the first contact 61a is formed on the rear surface of the flexible printed circuit board for an optical tube unit 61 to be electrically connected to the main printed circuit board 50. Here, the first contact 61a may be formed, for example, around a portion 60a of the optical tube unit 60 in order to function like the terminal 6a shown in FIG. 1.

In addition, the second contact 50a is formed, for example, on the upper surface of the main printed circuit board 50 which is assembled to the optical tube unit 60 in order to be electrically connected to the optical tube unit 60. Here, the second contact 50a is formed in order to function as a connector. Thus, the first contact 61a of the optical tube unit 60 and the second contact 50a of the main printed circuit board 50 are assembled together and form an electrical contact point when the optical tube unit 60 and the main printed circuit board 50 are assembled together using the first assembling element 74 such as, for example, a screw.

In other words, additional terminals or connectors are not necessary in order to connect the imaging device assembly and the main printed circuit board 50, or the optical tube assembly and the main printed circuit board 50, in the digital photographing apparatus according to the present invention.

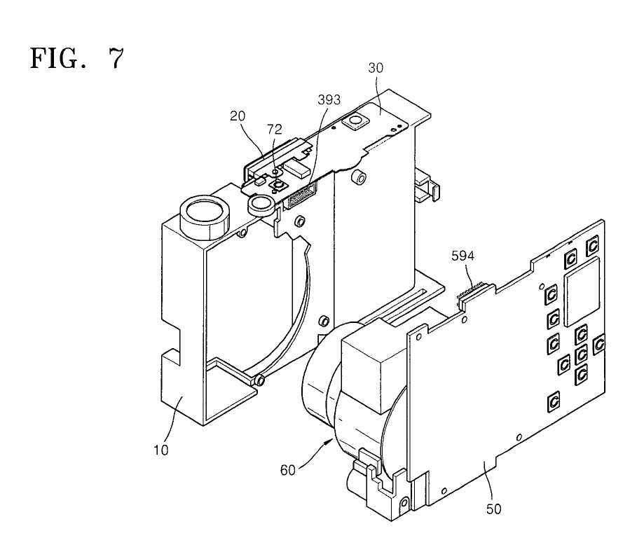

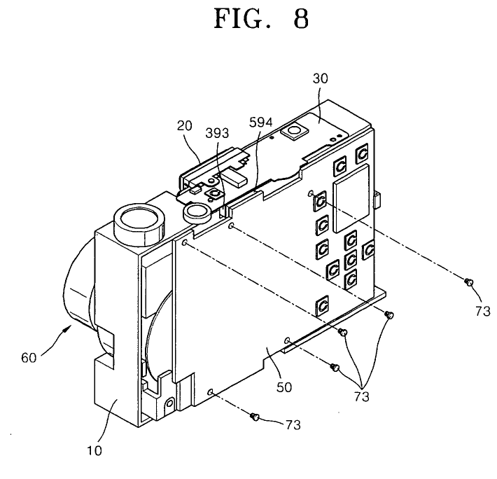

FIG. 7 is an exploded perspective view of an example of a digital photographing apparatus schematically illustrating a frame, a top printed circuit board assembly assembled to the frame, and a main printed circuit board-optical tube unit assembly, according to an embodiment of the present invention. FIG. 8 is a perspective view of an example of a digital photographing apparatus in which a main printed circuit board-optical tube assembly is assembled to a top printed circuit board, according to an embodiment of the present invention.

Referring to FIGS. 7 and 8, the digital photographing apparatus according to the present invention may further include, for example, a frame 10 and a top printed circuit board 30. The top printed circuit board 30, to which a button element disposed on the upper portion of the digital photographing apparatus is attached, is disposed on the frame 10. Here, the top printed circuit board 30 may be assembled to the frame 10 using a second assembling element 72 such as, for example, a screw as shown in FIGS. 7 and 8. In addition, a flash module 20 including a flash lamp may be assembled to the top printed circuit board 30. Here, the main printed circuit board 50 is disposed at a side of the frame 10 and may also be assembled to the frame 10 using a third assembling element 73 such as a screw.

Meanwhile, the top printed circuit board 30 includes a first connector 393 and the main printed circuit board 50 includes a second connector 594. The first connector 393 and the second connector 594 may be electrically connected to electrically connect the top printed circuit board 30 and the main printed circuit board 50. In particular, since the top printed circuit board 30 is assembled to the frame 10 and the main printed circuit board 50 is assembled to a side of the frame 10 as shown in FIGS. 7 and 8, the first connector 393 is automatically engaged with the second connector 594, and thus an additional electrically connecting means is not necessary (Board to Board connection). In a conventional digital photographing apparatus, a flash lamp in a flash module is electrically connected to a main printed circuit board through a separate flexible printed circuit board and a connector. However, in the digital photographing apparatus according to the present invention, for example, the flash module 20 is electrically connected to the main printed circuit board 50 through the top printed circuit board 30. As a result, the digital photographing apparatus is able to have a simple structure, can be manufactured through a simple process with a high yield, low manufacturing costs, and a low defect rate by reducing the number of elements.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A digital photographing apparatus comprising:
a main printed circuit board to which an imaging device converting energy of incident light into electrical signals is directly attached; and
an optical tube unit connected to the main printed circuit board and forming an image in the imaging device by receiving an external image,
wherein a first contact formed at a surface of the optical tube unit is directly in contact with a second contact formed at a surface of the main printed circuit board.

2. The digital photographing apparatus of claim 1, wherein the first contact and the second contact are electrically interconnected to electrically connect the optical tube unit and the main printed circuit board.

3. The digital photographing apparatus of claim 1, wherein the imaging device is attached to the main printed circuit board such that the rear surface of the imaging device contacts the surface of the main printed circuit board.

4. The digital photographing apparatus of claim 1, wherein the optical tube unit is directly assembled to the main printed circuit board such that light passing through the optical tube unit is incident onto the imaging device attached to the main printed circuit board.

5. The digital photographing apparatus of claim 4, further comprising:
a first assembling element assembling the optical tube unit and the main printed circuit board.

6. The digital photographing apparatus of claim 1, wherein the second contact is formed at a portion of the main printed circuit board corresponding to the first contact of the optical tube unit such that the first contact is in contact with the second contact when the optical tube unit is assembled to the main printed circuit board.

7. The digital photographing apparatus of claim 1, wherein the optical tube unit comprises a flexible printed circuit board for an optical tube unit, and the first contact is formed on a surface of the flexible printed circuit board for an optical tube unit.

8. The digital photographing apparatus of claim 1, further comprising:
a frame; and
a top printed circuit board (PCB) including a button element disposed on the upper portion of the digital photographing apparatus,
wherein the top printed circuit board is disposed on the upper portion of the frame and the main printed circuit board is disposed at a side of the frame.

9. A digital photographing apparatus comprising:
a non-flexible main printed circuit board;
an imaging device having a rear surface that contacts the main printed circuit board; and
an optical tube unit connected to the main printed circuit board in a manner that results in light passing through the optical tube unit being incident on the imaging device.

10. The digital photographing apparatus of claim 9, wherein the optical tube unit and the main printed circuit board are electrically interconnected via a first contact on the optical tube unit and a second contact on the main printed circuit board.

11. The digital photographing apparatus of claim 10, further comprising:
a first assembling element assembling the optical tube unit and the main printed circuit board.

12. The digital photographing apparatus of claim 10, wherein the second contact is formed at a portion of the main printed circuit board corresponding to the first contact of the optical tube unit such that the first contact is in contact with the second contact when the optical tube unit is assembled to the main printed circuit board.

13. The digital photographing apparatus of claim 10, wherein the optical tube unit comprises a flexible printed circuit board for an optical tube unit, and the first contact is formed on a surface of the flexible printed circuit board for an optical tube unit.

14. The digital photographing apparatus of claim 9, further comprising:
a frame; and
a top printed circuit board (PCB) including a button element disposed on the upper portion of the digital photographing apparatus,
wherein the top printed circuit board is disposed on the upper portion of the frame and the main printed circuit board is disposed at a side of the frame.

15. A digital photographing apparatus comprising:
a main printed circuit board;
an imaging means for converting energy of incident light into electrical signals, the imaging means being directly attached to the main printed circuit board; and
an optical tube means for forming an image in the imaging means by receiving an external image, the optical tube means being connected to the main printed circuit board,
wherein a first contact formed at a surface of the optical tube means is directly in contact with a second contact formed at a surface of the main printed circuit board.

16. The digital photographing apparatus of claim 15, wherein the first contact and the second contact are electrically interconnected to electrically connect the optical tube means and the main printed circuit board.

17. The digital photographing apparatus of claim 15, wherein the imaging means is attached to the main printed circuit board such that the rear surface of the imaging means contacts the surface of the main printed circuit board.

18. The digital photographing apparatus of claim 15, wherein the optical tube means is directly assembled to the main printed circuit board such that light passing through the optical tube means is incident onto the imaging means attached to the main printed circuit board.

19. The digital photographing apparatus of claim 18, further comprising:
a first assembling means assembling the optical tube means and the main printed circuit board.

20. The digital photographing apparatus of claim 15, wherein the optical tube means includes a flexible printed circuit board, and the first contact is formed on a surface of the flexible printed circuit board of the optical tube means.
